(19) United States
(12) Patent Application Publication
(10) Pub. No.: US 2026/0270177 A1
(43) Pub. Date: Sep. 10, 2026

(54) HOPSTAMP TRACEROUTE AND LATENCY MEASUREMENT UTILITY

(71) Applicant: Charter Communications Operating, LLC, St. Louis, MO (US)

(72) Inventor: Robert B Hulshof, Highlands Ranch, CO (US)

(73) Assignee: Charter Communications Operating, LLC, St. Louis, MO (US)

(21) Appl. No.: 19/074,733

(22) Filed: Mar. 10, 2025

(51) Int. Cl. H04L 43/0864; H04L 43/10

(52) U.S. Cl. CPC H04L 43/0864; H04L 43/10

(57) ABSTRACT

In certain embodiments, a source node in a communication network transmits a so-called hopstamp packet to a destination node, which re-transmits the hopstamp packet back to the source node to complete a round-trip path for the hopstamp packet. Each hop along the round-trip path populates a corresponding hopstamp field with at least the identity of the hop and the time delay between the hop receiving the hopstamp packet from the previous node of the round-trip path and the hop transmitting the hopstamp packet to the next node of the round-trip path. When the hopstamp packet arrives back at the source node, the populated hopstamp fields will identify at least the traceroute for the round-trip path and the time delay for each of hops in the round-trip path. This hop-level latency information can then be used to control the routing of data in the network.

### BACKGROUND

### Field of the Disclosure

The present disclosure relates to communication networks and, more specifically but not exclusively, to techniques for determining traceroutes and latencies in communication networks.

### Description of the Related Art

This section introduces aspects that may help facilitate a better understanding of the disclosure. Accordingly, the statements of this section are to be read in this light and are not to be understood as admissions about what is prior art or what is not prior art.

In communication networks, network latency measurement is crucial for assessing user quality of experience (QoE), since latency directly impacts the responsiveness and fluidity of applications. High latency can lead to delays in loading times, buffering during streaming, and sluggish interactions in online services, all of which can frustrate users and diminish their satisfaction. It is therefore very important to have an accurate way of measuring latency.

### SUMMARY

Each hop (e.g., router/server) in a network adds some time delay (aka router delay) to a packet due to packet processing/routing and queuing. In addition, some time delay (aka link delay) is added when the packet travels from one hop to the next. Simple latency measurements from the sender's perspective can be done by subtracting the time captured when a packet is sent from the time the response packet arrives. This provides the total round-trip-time (RTT) (i.e., overall latency), but, if there is an increase in the RTT, then there is no information on what network path was taken or where in the network the additional latency was added, so there is no useful information to address the latency.

Furthermore, if a sender wants to measure the latency of an existing flow, then a simple latency measurement packet would be a different flow (i.e., different 5-tuple) which will have a different routing path as the existing flow, and, as a result, the router delays will be different, and the measured RTT/latency will not be accurate.

In any case, measuring overall latency by itself is not sufficient if it does not provide information on where in the network the latency occurs. Therefore, for companies that provide internet services, it is important to have an accurate way of measuring latency for every part of the network. The current challenge with finding where in the network latency is added, is that there are currently no effective tools to determine the routing path (both forward and reverse) of an existing flow, or to accurately measure the latency for individual hops in the network.

The proposed “hopstamp” utility is designed to find the routing path and accurately measure latency in an easy, straightforward manner. Problems in the prior art are addressed in accordance with the principles of the present disclosure by employing so-called “hopstamp” packets having “hopstamp” fields that hops (e.g., routers) in a round-trip path from source node to destination node and back to the source node, populate with at least hop-id and time-delay values, where each hop-id value identifies a different hop and each corresponding time-delay value identifies the amount of time that the packet takes to traverse that hop (i.e., the duration between the packet's time of arrival at the hop and the packet's time of departure from the hop). When the completed hopstamp packet arrives back at the source node, the populated hopstamp fields identify all of the hops in the traceroute for the round-trip path and the time delay (i.e., latency) applied at each of those hops.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is diagram of an example, round-trip, communication-network path;

FIG. 2 is a representation of the structure of an ICMP hopstamp packet according to certain embodiments of the disclosure;

FIG. 3 is a representation of the structure of the ICMP header of FIG. 2 according to certain embodiments of the disclosure;

FIG. 4 is a representation of the structure of the hopstamp header of FIG. 2 according to certain embodiments of the disclosure;

FIG. 5 is a representation of the structure of each hopstamp field in the hopstamp payload of FIG. 2 according to certain embodiments of the disclosure;

FIG. 6 provides information about each sub-field of each hopstamp field in the hopstamp payload of FIG. 2 according to certain embodiments of the disclosure;

FIG. 7 contains a simplified block diagram representing the processing of a hopstamp packet of FIG. 2 at two different types of hops of FIG. 1; and

FIG. 8 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

FIG. 1 is diagram of an example, round-trip, communication-network path 100 from a source (i.e., sender) node 110 to a destination (i.e., receiver) node 120 and back to the source node 110 via intermediate hops (e.g., routers) 130(1)-130(6), where the one-way, “forward” (i.e., outbound, outgoing) portion 132 of the round-trip path 100 from the source node 110 to the destination node 120 comprises the sequence of hop 130(1), then hop 130(2), then hop 130(3), then hop 130(4), while the one-way, “return” (i.e., inbound, incoming) portion 134 of the round-trip path 100 from the destination node 120 back to the source node 110 comprises the sequence of hop 130(5), then hop 130(6), then hop 130(1). As illustrated by this example, the return portion may be, but does not have to be, different from the forward portion, and those two portions may, but do not have to, have one or more hops in common.

According to certain embodiments of the disclosure, the source node 110 transmits towards the destination node 120 along the forward portion 132, a hopstamp packet with a number of empty hopstamp fields, where that number is selected to be at least as large as the largest expected number of hops in a round-trip path in the corresponding communication network. As the hopstamp packet traverses each hop 130 in the forward portion 132, the hop 130 will populate the next, empty hopstamp field in the hopstamp packet with a set of hopstamp information (described in further detail below) that at the least identifies the hop 130 and the time delay of the packet at the hop 130.

When the hopstamp packet reaches the destination node 120, the destination node 120 will recognize that the packet is a hopstamp packet and will re-transmit the hopstamp packet back to the source node 110 via the return portion 134. The hopstamp header has a bit field that indicates direction. At the destination node 120, that bit is flipped to the other direction. That bit value enables, for example, the destination node 120 to distinguish between (i) received hopstamp packets that were initiated by the source node 120 and are half way through the round-trip path and (ii) received hopstamp packets that were initiated by the destination node 120 and have completed the round-trip path. In some embodiments, the destination node 120 populates the next empty hopstamp field in the hopstamp packet with its own ID and time delay. In those embodiments, the destination node 120 may be considered to be just another hop in the round-trip path 100.

In any case, each hop 130 in the return portion 134 will also populate the next, empty hopstamp field in the hopstamp packet with its own ID and time delay, such that, when the hopstamp packet arrives back at the source node 110, the populated hopstamp fields will identify the sequence of hops in the round-trip path 100 (i.e., the path's traceroute) and the time delays at those hops. Note that the number of populated hopstamp fields in the hopstamp packet will correspond to the number hops in the round-trip path 100 (possibly including the destination node 120) and that zero, one, or more remaining hopstamp fields in the hopstamp packet will be empty when the number of hops in the round-trip path 100 are fewer than the number of hopstamp fields in the hopstamp packet. As understood by those skilled in the art, the source node 110 (and/or the communication network at large) can use that traceroute and time-delay information to determine whether and how to proceed with non-hopstamp communications between the source node 110 and the destination node 120 as well as other communications involving some or all of those same hops 130.

If it turns out that the round-trip path has more hops than the number of hopstamp fields in the hopstamp packet, then each hop receiving the hopstamp packet with no empty hopstamp fields will forward the hopstamp packet without modifying it.

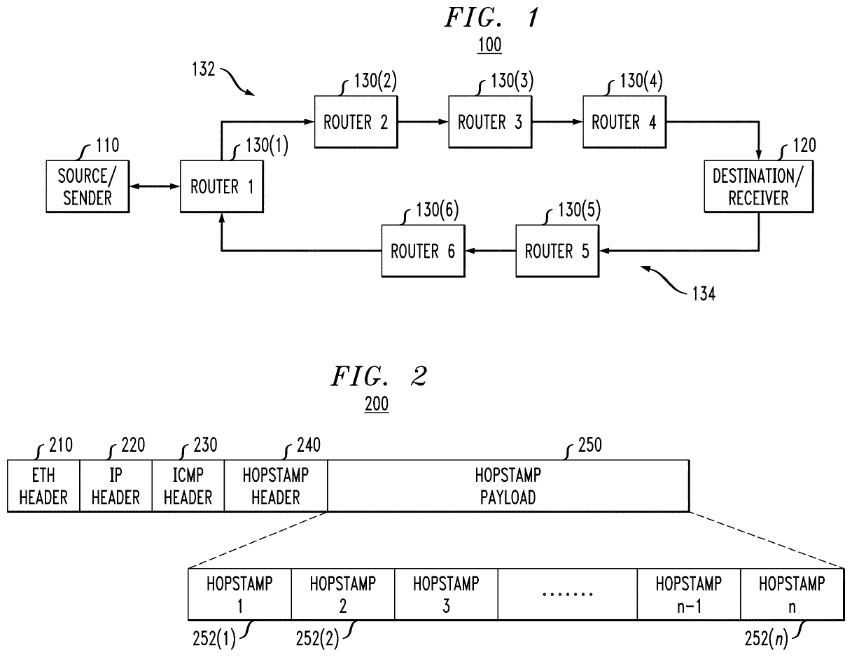

FIG. 2 is a representation of the structure of an ICMP hopstamp packet 200 according to certain embodiments of the disclosure. As shown in FIG. 2, in these embodiments, the hopstamp packet 200 comprises a standard Ethernet header 210, followed by a standard Internet protocol (IP) header 220, followed by an Internet Control Message Protocol (ICMP) header 230, followed by a hopstamp header 240, followed by a hopstamp payload 250, which comprises a sequence of n hopstamp fields 252(1), . . . 252(n), where n is an integer greater than the expected maximum number of hops in a round-trip path in the communication network.

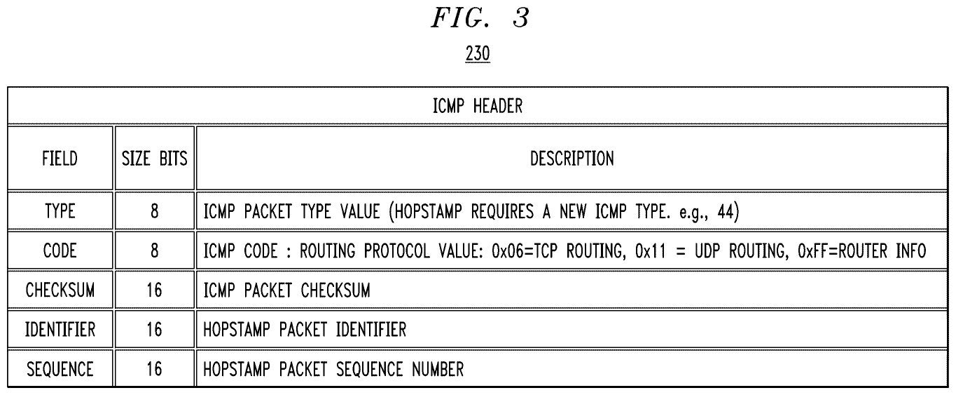

FIG. 3 is a representation of the structure of the ICMP header 230 of FIG. 2, according to certain embodiments of the disclosure. The format of the ICMP header 230 is the same as standard ICMP headers. The IGMP header 230 shows that the hopstamp packet would be a new type of ICMP packet, indicated by the “type” field. The header 230 of this new ICMP type has hopstamp protocol specific information in the ICMP header “code”, “identifier”, and “sequence” fields.

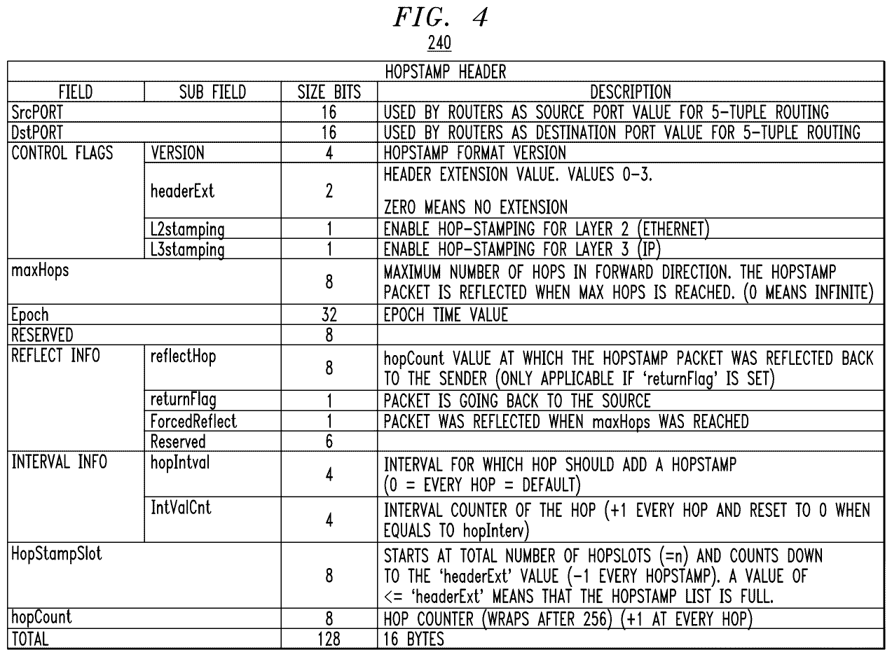

FIG. 4 is a representation of the structure of the hopstamp header 240 of FIG. 2, according to certain embodiments of the disclosure. For a hop 130 to be able to route a hopstamp packet to a specific destination, the hop 130 needs to be able to construct the same 5-tuple as the flow for which the client is trying to get the path and latency information. Since the ICMP packet header 230 of FIG. 3 does not have source port or destination port fields, the hopstamp header 240 has SrcPort and DstPort fields to provide that information.

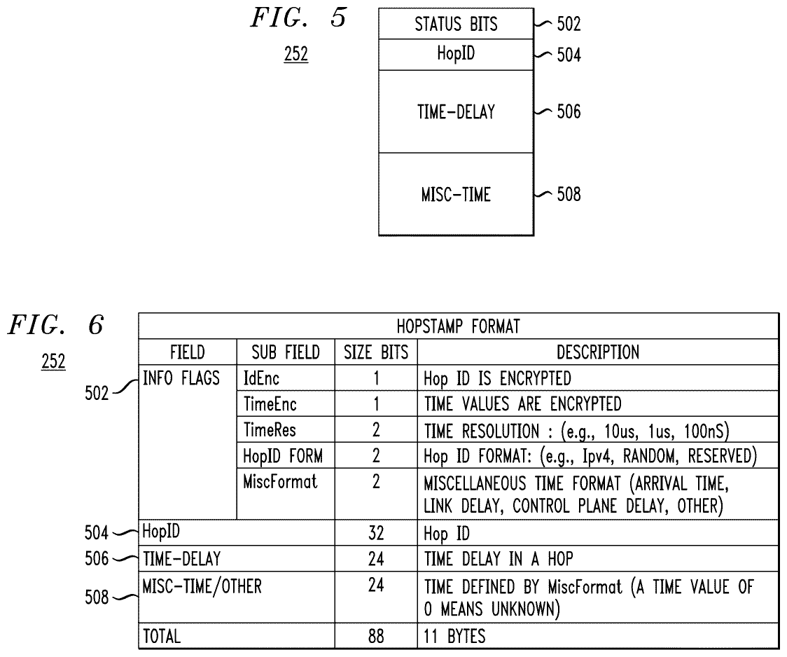

FIG. 5 is a representation of the structure of each hopstamp field 252 of FIG. 2 and FIG. 6 provides information about each sub-field of each hopstamp field 252 in the hopstamp payload 250 of FIG. 2, according to certain embodiments of the disclosure. Each hopstamp field 252 comprises a status-bits sub-field 502, followed by a hop identification (hop-id) sub-field 504, followed by a time-delay sub-field 506, followed by a miscellaneous time (misc-time) sub-field 508.

The status-bits sub-field 502 may define some or all of hopstamp type, encryption status bits, time-resolution definition bits, and miscellaneous time-format bits.

The hop-id sub-field 504 identifies the corresponding hop 130 that populates the corresponding hopstamp field 252. The hop-id value stored in the hop-id sub-field 504 may be the IP address or other suitable, unique identifier for the hop 130. 32 bits for the hop-id sub-field 504 allows storing of more than 100 hopstamps in a single network packet, which is large enough to store uncompressed IPv4 addresses. That is too short to store IPv6 addresses or domain names, but is large enough that a probability of collisions in a network path is low if a random number is selected as the hop id. Each hop 130 may have support to convert a hop ID to a host name and/or an IP address. A special hopstamp packet (e.g., ICMP code 255) may be used to retrieve additional information from the hop 130, which includes hop ID, host name, time resolution, encryption options, etc.

The time-delay sub-field 506 stores the time delay of the hopstamp packet at the hop 130.

The misc-time sub-field 508 stores data corresponding to the value of the MiscFormat bits in the status-bits sub-field 502.

As understood by those skilled in the art, the source IP address and the destination IP address in the IP header 220, the ICMP code in the ICMP header 230, and the source port and destination port in the hopstamp header 240 constitute the information of a conventional 5-tuple that identifies the network flow to which the hopstamp packet 200 belongs, where the ICMP code identifies the routing protocol for the flow. It will also be understood that the present disclosure can be used to determine the traceroute and hop time delays for an existing network flow by generating a hopstamp packet having the same 5-tuple for routing in the same way as for routing a UDP/TCP packet 5-tuple.

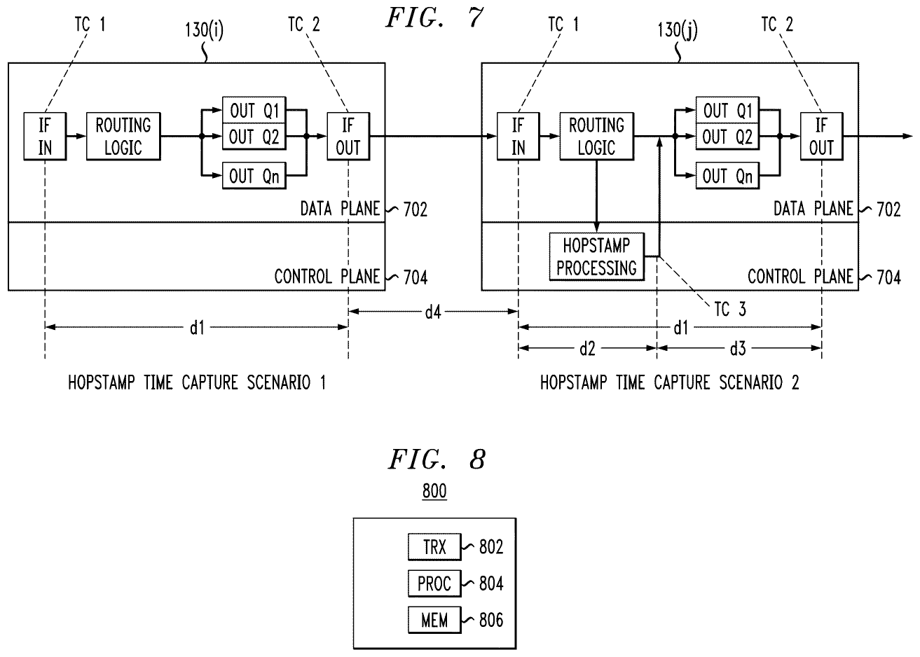

To support the population of hopstamp fields, a hop 130 captures the time when a hopstamp packet arrives at the input interface (IF in of FIG. 7) and when the packet leaves the hop on the output interface (IF out). The delay time in the hop 130 (d1) is calculated by taking the time captured at the output (TC2) minus the time captured at the input (TC1). This time delay is then written in the hopstamp ‘time-delay’ sub-field. Optionally, the hop 130 can also fill in the misc-time field in the hopstamp field.

There are two ways/scenarios for a hop to generate a time-delay value. In a first way/scenario, the hopstamp packet stays in the hop's data plane and the hop calculates on the fly the time delay in the hop and adds the time-delay value to the corresponding hopstamp field. Optionally, the hop adds the hopstamp packet arrival time (TC1) to the ‘misc-time’ sub-field. The hop also updates the status field in the hopstamp packet header. Most of the time delay in the hop will typically be in the output queues (Q1-Qn). In this way/scenario, the hopstamp packet stays in the data plane so the delay measurement will be very accurate.

In the second way/scenario, the hopstamp packet is sent to the hop's control plane, processed, and, after processing, sent to one of the output queues. This adds a variable delay to the hopstamp packet as the control plane will wait to handle the hopstamp packet when it has time to do so. The misc-time sub-field in the hopstamp field can be used to add the control-plane processing delay to the hopstamp field. This additional delay affects the router delay measurements in an unwanted way, but having the control-plane processing delay value in the hopstamp packet allows correcting for these delays afterwards when the hopstamp packet is received at the source node 110.

FIG. 7 contains a simplified block diagram representing the processing of a hopstamp packet 200 of FIG. 2 at a first type of hop 130(i) of FIG. 1 that processes hopstamp packets entirely at the hop's data plane 702. If this first type of hop 130(i) also processes routine (i.e., non-hopstamp) data packets entirely at the hop's data plane 702, then the time-delay value inserted into the time-delay sub-field 506 of FIG. 5 in the corresponding hopstamp field 252 of the hopstamp packet 200 will be approximately identical to the time delay associated with processing routine data packets at that same hop 130(i).

FIG. 7 also contains a simplified block diagram representing the processing of a hopstamp packet 200 of FIG. 2 at a second type of hop 130(j) of FIG. 1 that processes hopstamp packets in part at the hop's data plane 702 and in part at the hop's control plane 704. If this second type of hop 130(j) processes routine data packets entirely at the hop's data plane 702, then the time-delay value inserted into the time-delay sub-field 506 of FIG. 5 in the corresponding hopstamp field 252 of the hopstamp packet 200 might not be sufficiently close to the time delay associated with processing routine data packets at that same hop 130(j). Instead, as represented in FIG. 7, d2 is the time delay associated with the control-plane processing of the hopstamp packet 200 within hop 130(j), d3 is the time delay associated with the data-plane processing of the hopstamp packet 200 within hop 130(j), such that d1=d2+d3 will be the time-delay value inserted into the time-delay sub-field 506 by hop 130(j). In this case, the hop 130(j) can store the control-plane time-delay value d2 in the misc-time sub-field 508 of the corresponding hopstamp field 252 of the hopstamp packet 200, and the source node 110 can subtract that value d2 from the time-delay value d1 to calculate the data-plane time-delay value d3 associated with processing routine data packets at that hop 130(j).

Note that, in some embodiments, a hop 130 stores the data-plane time-delay value d3 in the time-delay field 506. Furthermore, storing both the control-plane time-delay d2 and the data-plane time-delay value d3 in the hopstamp field 252 will give even better indication of total link delays.

In other embodiments, the misc-time sub-field 508 may be used for any of the following sets of information:
Packet arrival timestamp (TC1 of FIG. 7). For this timestamp to be effective, all routers 130 in the network need to have their time synchronized to a precision time reference. Synchronized time allows the source node 110 to calculate the static link delays (d4 in FIG. 7), which cannot be individually determined by the time delays only.
Estimated link delay between this router 130 and the next router 130. Most routers 130 measure link delays (e.g., d4 in FIG. 7) to the next routers for routing purposes. This option enables the hop 130(i) to provide the link-delay value d4 to the source node 110, which cannot be individually determined by the time delays only.
No-time. The router 130 did not have useful data to fill in the misc-time sub-field.
Future time options TBD.

FIG. 8 is a simplified hardware block diagram of an example node 800 that can be used to implement any of the nodes 110, 120, and 130 of FIG. 1. As shown in FIG. 8, the node 800 includes (i) communication hardware (e.g., wireless, wireline, and/or optical transceivers (TRX)) 802 that supports communications with other nodes, (ii) one or more processors (e.g., CPU and/or GPU microprocessors) 804 that control the operations of the node 800 and/or process data within the node 800, and (iii) one or more memories (e.g., RAM, ROM) 806 that store code executed by the processors 804 and/or data generated and/or received by the node 800.

As used herein, the term “hop” refers to a device that forwards a hopstamp packet towards either the destination node or back towards the sender depending on the hopstamp packet's direction. A hop is typically a router but can also be a server (e.g., the destination node) that reflects the hopstamp packet back to the source node.

As used herein, the term “hopstamp field” refers to the binary data structure with allocated space for a time delay, router identifier, and status bits.

Although the disclosure has been described in the context of hopstamp packets having a fixed number of hopstamp fields, in other embodiments, the number of hopstamp fields may be variable, where each hop (and possibly the destination node) dynamically appends an additional hopstamp field to the end of the received hopstamp packet.

The disclosure has been described in the context of hopstamp packets that make traverse round-trip paths from a source node to a destination node and back to the source node, where the hopstamp packet that arrives back at the source node identifies the traceroute for the entire round-trip path and the time delays at each hop in the round-trip path. In other embodiments, the hopstamp packets traverse only one-way paths from a source node to a destination node, where the hopstamp packet that arrives at the destination node identifies the traceroute for the one-way path and the time delays at each hop in the one-way path. A separate hopstamp packet may be transmitted from that destination node to that source node via the same or different one-way path to identify the traceroute and hop time delays for that one-way path.

In certain embodiments, the present disclosure is a node for a communication network. The node comprises a memory and at least one processor, coupled to the memory and operative to (i) receive an incoming hopstamp packet and (ii) transmit an outgoing hopstamp packet, wherein each hopstamp packet comprises a plurality of hopstamp fields, each hopstamp field configured to identify a time-delay value corresponding to a duration of time that the hopstamp packet resides in a corresponding node in a round-trip path between a source node and a destination node of the communication network.

In at least some of the above embodiments, the node is the source node, and the source node is configured to transmit the outgoing hopstamp packet having empty hopstamp fields and receive the incoming hopstamp packet having a time-delay value in the hopstamp field corresponding to each hop in the round-trip path.

In at least some of the above embodiments, the incoming hopstamp packet comprises a hopstamp field having a time-delay value corresponding to the destination node.

In at least some of the above embodiments, the node is the destination node, and the destination node is configured to (i) receive the incoming hopstamp packet having a time-delay value in the hopstamp field corresponding to each hop in a forward portion of the round-trip path corresponding to a one-way path from the source node to the destination node and (ii) transmit a version of the incoming hopstamp packet as the outgoing hopstamp packet towards the source node in a return portion of the round-trip path.

In at least some of the above embodiments, the outgoing hopstamp packet comprises a hopstamp field having a time-delay value corresponding to the destination node.

In at least some of the above embodiments, the node is a hop in the round-trip path, and the hop is configured to (i) receive the incoming hopstamp packet from a previous node in the round-trip path, (ii) determine a time-delay value for the incoming hopstamp packet, (iii) insert the time-delay value into the incoming hopstamp packet to create the outgoing hopstamp packet; and (iv) transmit the outgoing hopstamp packet to a next node in the round-trip path.

In at least some of the above embodiments, the hop is the destination node.

In at least some of the above embodiments, each hopstamp field is further configured to identify the corresponding node.

In at least some of the above embodiments, each hopstamp field is further configured to identify one or more of hopstamp type, encryption status, time resolution definition, time format, arrival time of the hopstamp packet at the corresponding node, link delay between the corresponding node and the next node in the round-trip path, and a time-delay value corresponding to control-plane delay within the corresponding node.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A node for a communication network, the node comprising:
a memory; and
at least one processor, coupled to the memory and operative to:
receive an incoming hopstamp packet; and
transmit an outgoing hopstamp packet, wherein each hopstamp packet comprises a plurality of hopstamp fields, each hopstamp field configured to identify a time-delay value corresponding to a duration of time that the hopstamp packet resides in a corresponding node in a round-trip path between a source node and a destination node of the communication network.

2. The node of claim 1, wherein:
the node is the source node; and
the source node is configured to:
transmit the outgoing hopstamp packet having empty hopstamp fields; and
receive the incoming hopstamp packet having a time-delay value in the hopstamp field corresponding to each hop in the round-trip path.

3. The node of claim 2, wherein the incoming hopstamp packet comprises a hopstamp field having a time-delay value corresponding to the destination node.

4. The node of claim 1, wherein:
the node is the destination node; and
the destination node is configured to:
receive the incoming hopstamp packet having a time-delay value in the hopstamp field corresponding to each hop in a forward portion of the round-trip path corresponding to a one-way path from the source node to the destination node; and
transmit a version of the incoming hopstamp packet as the outgoing hopstamp packet towards the source node in a return portion of the round-trip path.

5. The node of claim 4, wherein the outgoing hopstamp packet comprises a hopstamp field having a time-delay value corresponding to the destination node.

6. The node of claim 1, wherein:
the node is a hop in the round-trip path; and
the hop is configured to:
receive the incoming hopstamp packet from a previous node in the round-trip path;
determine a time-delay value for the incoming hopstamp packet;
insert the time-delay value into the incoming hopstamp packet to create the outgoing hopstamp packet; and
transmit the outgoing hopstamp packet to a next node in the round-trip path.

7. The node of claim 6, wherein the hop is the destination node.

8. The node of claim 1, wherein each hopstamp field is further configured to identify the corresponding node.

9. The node of claim 8, wherein each hopstamp field is further configured to identify one or more of:
hopstamp type;
encryption status;
time resolution definition;
time format;
arrival time of the hopstamp packet at the corresponding node;
link delay between the corresponding node and the next node in the round-trip path; and
a time-delay value corresponding to control-plane delay within the corresponding node.

10. A method for node for a communication network, the method comprising:
receiving an incoming hopstamp packet; and
transmitting an outgoing hopstamp packet, wherein each hopstamp packet comprises a plurality of hopstamp fields, each hopstamp field configured to identify a time-delay value corresponding to a duration of time that the hopstamp packet resides in a corresponding node in a round-trip path between a source node and a destination node of the communication network.

11. The method of claim 10, wherein:
the node is the source node; and
the source node:
transmits the outgoing hopstamp packet having empty hopstamp fields; and
receives the incoming hopstamp packet having a time-delay value in the hopstamp field corresponding to each hop in the round-trip path.

12. The method of claim 11, wherein the incoming hopstamp packet comprises a hopstamp field having a time-delay value corresponding to the destination node.

13. The method of claim 10, wherein:
the node is the destination node; and
the destination node:
receives the incoming hopstamp packet having a time-delay value in the hopstamp field corresponding to each hop in a forward portion of the round-trip path corresponding to a one-way path from the source node to the destination node; and
transmits a version of the incoming hopstamp packet as the outgoing hopstamp packet towards the source node in a return portion of the round-trip path.

14. The method of claim 13, wherein the outgoing hopstamp packet comprises a hopstamp field having a time-delay value corresponding to the destination node.

15. The method of claim 10, wherein:
the node is a hop in the round-trip path; and
the hop:
receives the incoming hopstamp packet from a previous node in the round-trip path;
determines a time-delay value for the incoming hopstamp packet;
inserts the time-delay value into the incoming hopstamp packet to create the outgoing hopstamp packet; and
transmits the outgoing hopstamp packet to a next node in the round-trip path.

16. The method of claim 15, wherein the hop is the destination node.

17. The method of claim 10, wherein each hopstamp field identifies the corresponding node.

18. The method of claim 17, wherein each hopstamp field further identifies one or more of:
hopstamp type;
encryption status;
time resolution definition;
time format;
arrival time of the hopstamp packet at the corresponding node;
link delay between the corresponding node and the next node in the round-trip path; and
a time-delay value corresponding to control-plane delay within the corresponding node.
